(19) United States
(12) Patent Application Publication
(10) Pub. No.: US 2020/0229999 A1
(43) Pub. Date: Jul. 23, 2020

(54) Transport Apparatus for Weak Person

(71) Applicant: Kevin Chih-Yu Chien, Coquitlam (CA)

(72) Inventor: Kevin Chih-Yu Chien, Coquitlam (CA)

(21) Appl. No.: 16/252,807

(22) Filed: Jan. 21, 2019

(51) Int. Cl. A61G 5/14; A61G 5/04; A61G 5/10; A61G 5/12

(52) U.S. Cl. CPC A61G 5/14; A61G 5/125; A61G 5/1045; A61G 5/041

(57) ABSTRACT

A transport apparatus for weak person has a mobile chassis for transporting the weak person, a powered lifting mechanism and a seating assembly assembled on the mobile chassis. The lifting mechanism has a lifting arm connected to be driven to pivot upward or downward by an actuator, and an armpit supporting device assembled on an upper end of the lifting arm. The seating assembly has a seat supporting mechanism, and two seat plates mounted on the left and right seating arms of the seat supporting mechanism and are connected to and driven by two driving assemblies respectively to form a seat for the weak person to sit thereon.

### BACKGROUND OF THE INVENTION

### 1. Field of the Invention

The present invention relates to a transport apparatus, especially to a transport apparatus for moving a weak person.

### 2. Description of the Prior Art(s)

A conventional transport apparatus for moving people with mobility problems is a wheelchair which may be manually or electrically driven.

Another conventional transport apparatus for moving physically disabled people is a device having a sling for hanging the physically disabled people from one place to another place.

However, before using the conventional transport apparatuses, a user, that is the person with mobility problems or the physically disabled person, needs help from care workers to move him/her from a bed, a toilet or a car to the conventional transport apparatuses, or to move him/her from the conventional transport apparatuses to the bed, the toilet or the car. Specifically, the care worker has to carry the user with his/her arms, which is laborious and dangerous. The user cannot be moved directly by the transport apparatus.

To overcome the shortcomings, the present invention presents a transport apparatus for the weak person to mitigate or obviate the aforementioned problems.

### SUMMARY OF THE INVENTION

The main objective of the present invention is to provide a transport apparatus for weak person. The transport apparatus is comprised of a mobile chassis for transporting the weak person, a lifting mechanism to lift the weak person from a seated position to sit on a seat formed by seat plates or vice versa, and a seating assembly to form the seat for the weak person to sit thereon.

The lifting mechanism is comprised of an actuator, a lifting arm, and an armpit supporting device. The actuator is assembled on the mobile chassis. The lifting arm is connected to and extends from the actuator, and is driven to pivot upward or downward by the actuator. The armpit supporting device is assembled on an upper end of the lifting arm.

The seating assembly is comprised of a seat supporting mechanism and two seat plates. The seat supporting mechanism is mounted on the mobile chassis. The two seat plates are mounted on two seating arms of the seat supporting mechanism, and are connected to and driven by two driving assemblies respectively to form a seat.

The weak person can be moved directly by the transport apparatus and the transport apparatus can be operated by voice command from the weak person or care workers, or by the remote control which is under the control of the weak person or the care workers.

Other objectives, advantages and novel features of the invention will become apparent from the following detailed descriptions when taken in conjunction with the accompanied drawings.

### BRIEF DESCRIPTION OF THE DRAWINGS

FIG. 1 is a front perspective view of a transport apparatus for weak person in accordance with the present invention;

FIG. 2 is a rear perspective view of the transport apparatus in FIG. 1, wherein position restoring elements are tension springs;

FIG. 3 is an operational side view of the transport apparatus in FIG. 1, wherein the transport apparatus is beside a bed, with the weak person in a sitting position on the bed;

FIG. 4 as a continuation of FIG. 3 is an operational side view of the transport apparatus in FIG. 1, wherein the transport apparatus has approached the bed, with the weak person ready to be lifted by the transport apparatus;

FIG. 5 as a continuation of FIG. 4 is an operational side view of the transport apparatus in FIG. 1, wherein the weak person has been lifted by the transport apparatus;

FIG. 6 as a continuation of FIG. 5 is an operational side view of the transport apparatus in FIG. 1, wherein the weak person is lowered to sit on two seat plates of a seating assembly of the transport apparatus;

FIG. 7 is a schematic cross-sectional side view of the transport apparatus in FIG. 1, wherein a lifting arm of a lifting mechanism is raised, the seating arms came in touch with the lower guard stops and the seat plates are raised;

FIG. 8 is a schematic cross-sectional side view of the transport apparatus in FIG. 6, wherein the lifting arm of the lifting mechanism is lowered, the seating arms came in touch with the upper guard stop and the seat plates are lowered to form a seat;

FIG. 9 is a rear perspective view of a transport apparatus for weak person in accordance with the present invention, wherein position restoring elements are gas springs;

FIG. 10 is an enlarged left side view of a driving assembly of the transport apparatus in FIG. 1; and

FIG. 11 is an enlarged operational rear view of the driving assemblies of the transport apparatus in FIG. 1.

### DETAILED DESCRIPTION OF THE PREFERRED EMBODIMENTS

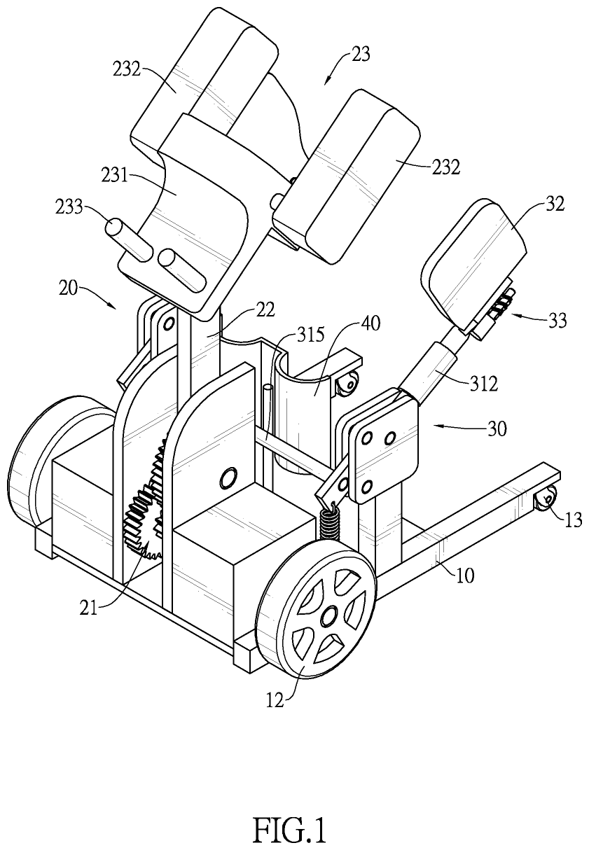

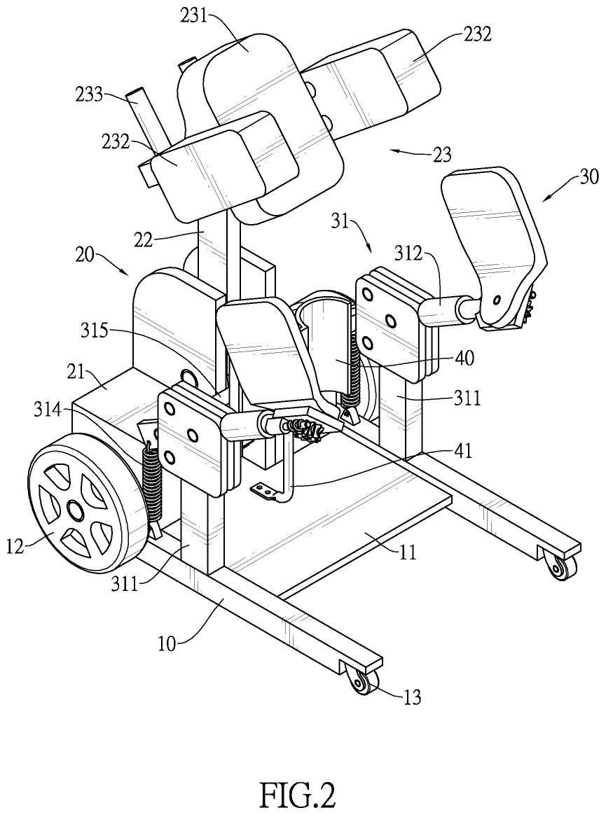

With reference to FIGS. 1, 2, and 6, a transport apparatus for weak person 50 in accordance with the present invention is comprised of a mobile chassis 10, a lifting mechanism 20, a seating assembly 30, and a knee support 40.

With reference to FIGS. 1 to 3, the mobile chassis 10 is for transporting a user, that is, the weak person 50, from or to a bed 61 or a chair, and includes at least one foot rest marking 11. The at least one foot rest marking 11 is formed on the upper surface of the mobile chassis 10 for indicating to the weak person 50 where to step on.

Two motorized wheels 12 are assembled on a front portion of the mobile chassis 10 and are located on left and right sides of the mobile chassis 10 respectively. Multiple supporting wheels 13 are assembled on a rear portion of the mobile chassis 10. Each of the supporting wheels 13 may be, but is not limited to, a swivel caster wheel. The rear portion of the mobile chassis 10 along with the supporting wheels 12 can run into a space between the floor and the bed 61 or between the floor and the chair.

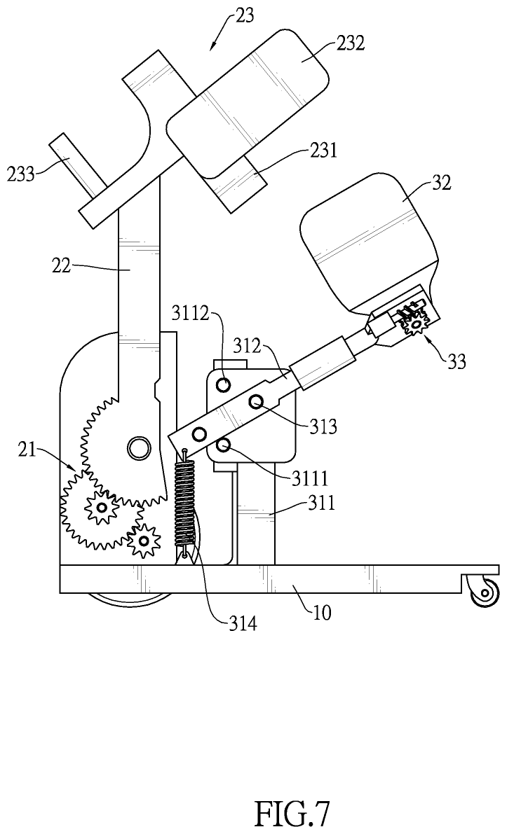

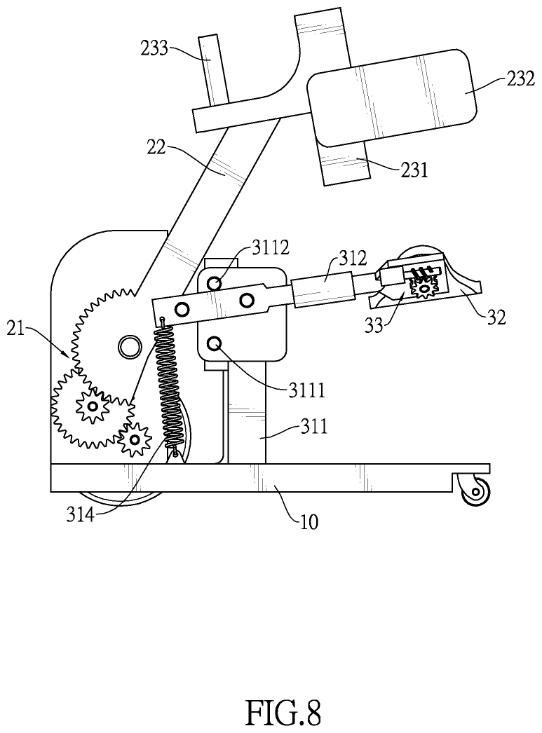

With further reference to FIGS. 7 and 8, the lifting mechanism 20 is comprised of an actuator 21, a lifting arm 22, and an armpit supporting device 23.

The actuator 21 is assembled on the front portion of the mobile chassis 10. The lifting arm 22 is connected to and extends from the actuator 20, and is driven to pivot upward or downward by the actuator 21.

The armpit supporting device 23 is assembled on an upper end of the lifting arm 22 and is raised or lowered along with the lifting arm 22 to lift or lower the weak person 50. The armpit supporting device 23 is comprised of a chest rest 231, two embracing arms 232, and at least one handle 233. The chest rest 231 is mounted on the upper end of the lifting arm 22. The two embracing arms 232 are mounted on left and right sides of the chest rest 231 respectively. The distance between the two embracing arms 232 is adjustable to fit the chest width of the weak person. The at least one handle 233 is mounted in front of the chest rest 231.

The seating assembly 30 is comprised of a seat supporting mechanism 31 and two seat plates 32. The seat supporting mechanism 31 is mounted on the mobile chassis 10. The two seat plates 32 are mounted on two seating arms 312 of the seat supporting mechanism 31. Each of the seat plates 32 is connected to and is driven by a driving assembly 33.

In the preferred embodiment, the seat supporting mechanism 31 is comprised of two mounting columns 311, said two seating arms 312, two position restoring elements 314, and a fixed linkage 315.

The two mounting columns 311 are mounted on the mobile chassis 10 and are located on the left and right sides of the mobile chassis 10 respectively. Each of the mounting columns 311 has a pivot 313, a lower guard stop 3111, and an upper guard stop 3112.

The seating arms 312 are connected to the pivots 313 on upper ends of the left and right mounting columns 311 respectively, and this allows a seesaw movement of the seating arms 312. The pivot 313 is located between the lower guard stop 3111 and the upper guard stop 3112. When the seating arms 312 pivots relative to the mounting columns 311, the seating arms 312 can come in touch with the lower guard stops 3111 or the upper guard stops 3112. The rotating range of the seating arm 312 is limited by the lower guard stop 3111 and the upper guard stop 3112. Furthermore, each of the seating arms 312 has a front end extending toward the front portion of the mobile chassis 10 and a rear end extending toward the rear portion of the mobile chassis 10. The two seat plates 32 are mounted on the rear ends of the left and right seating arms 312 respectively.

The position restoring elements 314 are connected to the two seating arms 312 respectively, and are connected to the mobile chassis 10.

In the preferred embodiment, the point where a position restoring element 314 and a seating arm 312 meets, is located between the pivot 313 and the front end of the seating arm 312, and the position restoring element 314 is a tension spring.

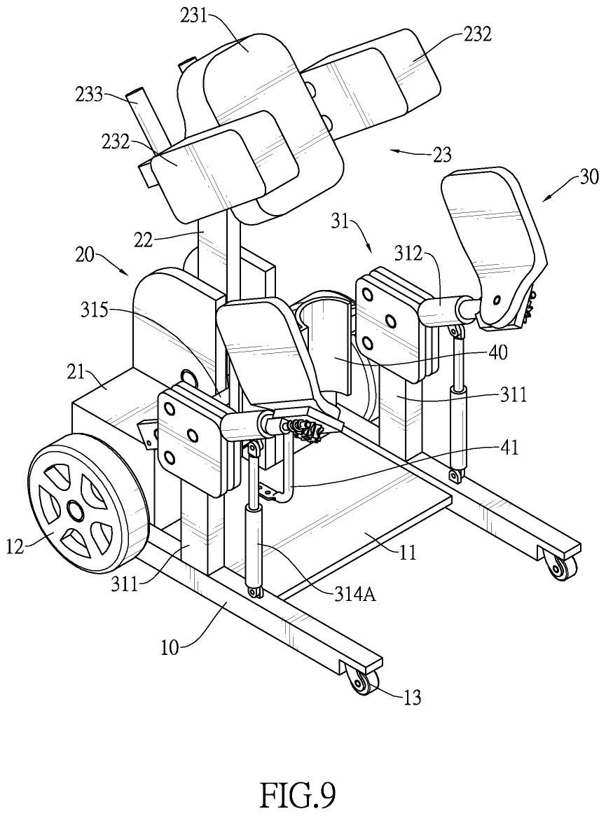

With reference to FIG. 9, in another preferred embodiment, the point where a position restoring element 314A and a seating arm 312 meets, is located between the pivot 313 and the rear end of the seating arm 312, and the position restoring element 314A is a gas spring or a compression spring.

The fixed linkage 315 connects the left and right seating arms 312, and ensures that the left and right seating arms 312 pivots simultaneously and the two seat plates 32 are always at the same height.

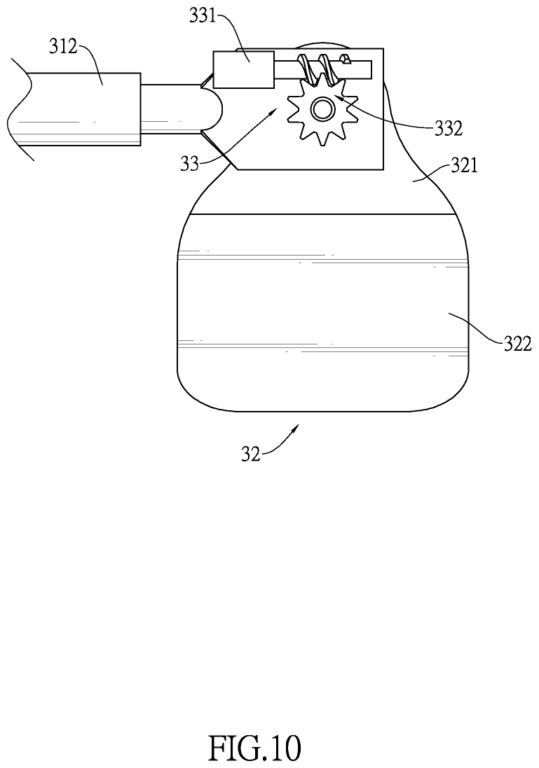

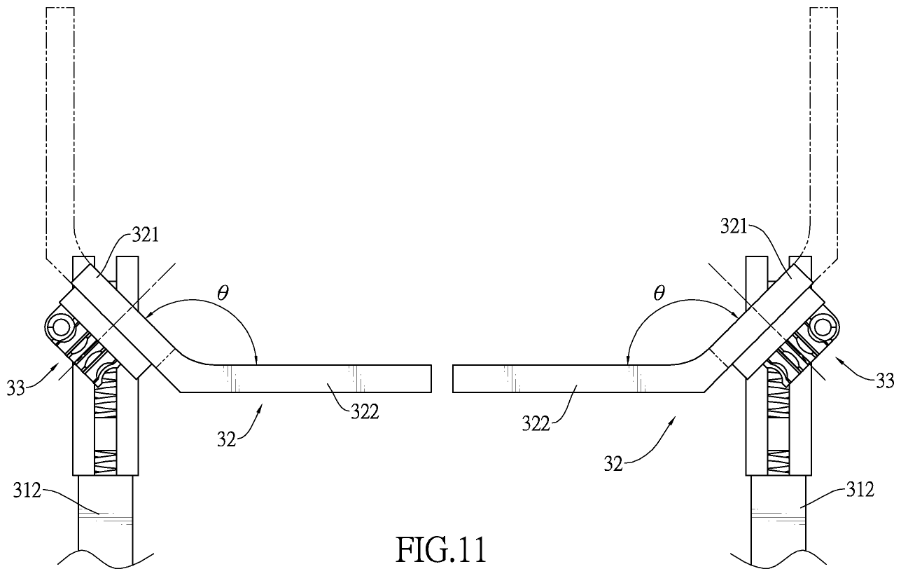

With further reference to FIGS. 10 and 11, the driving assemblies 33 are comprised of the left driving assembly 33L and the right driving assembly 33R, and both are installed symmetrically on the rear ends of the left and right seating arms 312 respectively. Each of the driving assemblies 33 for driving the seat plates 32 is comprised of a motor drive 331 and a gear set 332, and the gear set 332 is connected to the motor drive 331 and the seat plate 32. The motor drive 331 drives the gear set 332, whereby the gear set 332 rotates the seat plate 32.

As shown in FIG. 11, each of the seat plates 32 has a connecting portion 321 and a sitting portion 322. The connecting portion 321 is mounted on the seating arm 312 and is connected to the gear set 332. An angle θ between the connecting portion 321 and the sitting portion 322 is about 135 degrees. Thus, when the seat plates 32 are spun to allow the sitting portions 322 to extend upward, the weak person 50 can pass through a space between the two mounting columns 311. When the seat plates 32 are spun to be lowered, the two seat plates 32 form the seat for the weak person 50 to sit thereon.

The knee support 40 is mounted on the mobile chassis 10 via a knee support spring 41 and is located between the mounting columns 311. The function of the knee support 40 and knee support spring 41, are to provide support for the knees when the weak person is in the process of being raised or lowered by the transport apparatus.

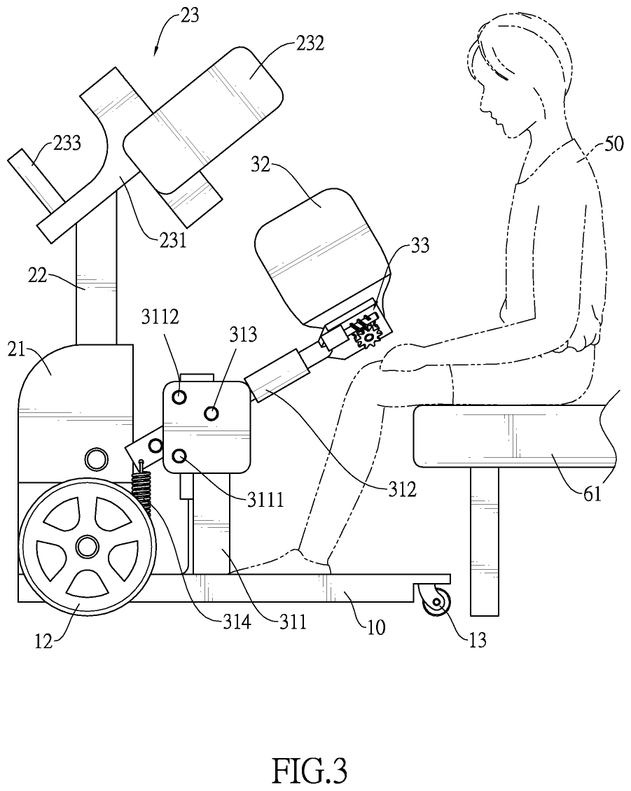

With reference to FIG. 3, the transport apparatus of the present invention can be operated by voice command or by a remote control. The weak person 50 sits on a side of the bed 61 and calls for the transport apparatus by voice command or by the remote control. The transport apparatus approaches the side of the bed 61 and the weak person 50 raises his/her feet to step onto the foot rest marking 11 of the mobile chassis 10.

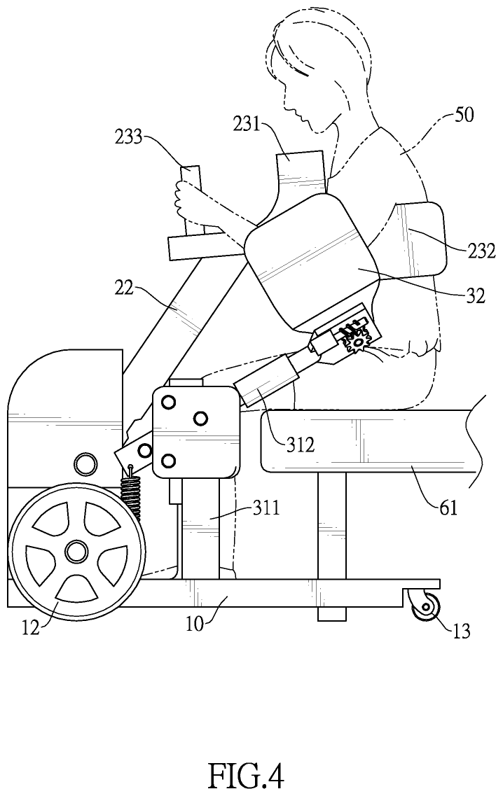

With further reference to FIG. 4 as a continuation from FIG. 3, the lifting arm 22 and the armpit supporting device 23 are lowered in a curved track to above the thighs of the weak person 50. Then the weak person 50 places both arms on top of the chest rest 231 and the transport apparatus moves further toward the bed 61, and the supporting wheels 12 move further into the space between the floor and the bed 61. The movement of the transport apparatus allows the two embracing arms 232 to tuck under the armpits of the weak person 50 and the knees of the weak person 50 to come in contact with the knee support 40.

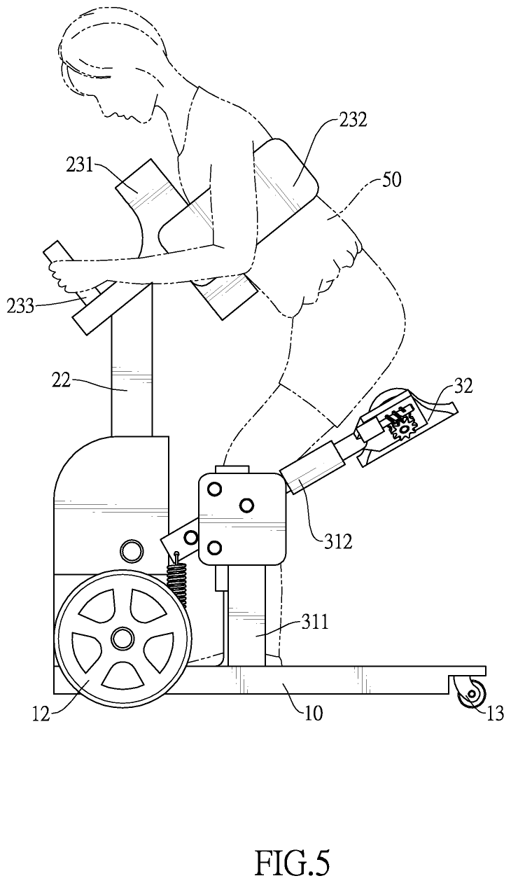

With further reference to FIG. 5 as a continuation from FIG. 4, the weak person 50 leans forward to allow his/her chest to come in contact with the chest rest 231, and for the weak person 50 to hold onto the handle 233. Then the lifting arm 22 and the armpit supporting device 23 are raised in a curved track, so as to move the weak person 50 away from the sitting position, and shift the center of mass of the weak person 50 towards the transport apparatus. Then the transport apparatus moves away from the bed 61 and the two seat plates 32 are driven by the left and right driving assemblies 33 to spin lowered to form a seat below the hip of the weak person 50.

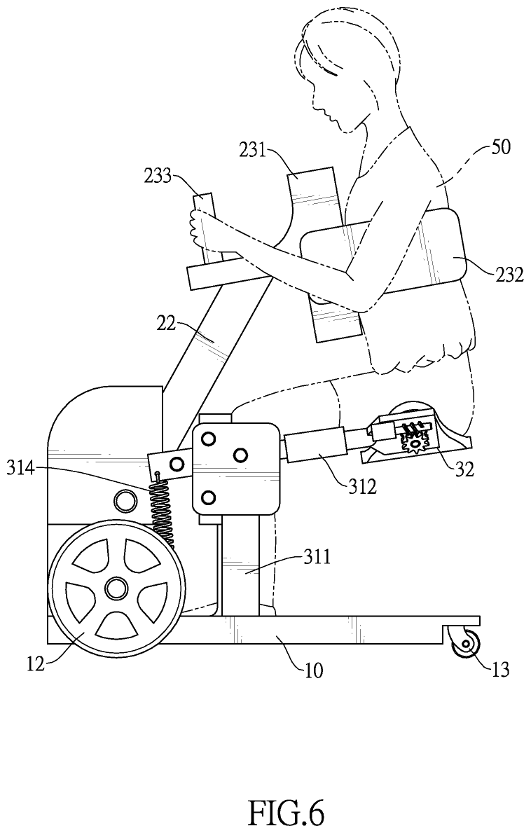

With further reference to FIG. 6 as a continuation from FIG. 5, the lifting arm 22 and the armpit supporting device 23 are lowered again to allow the weak person 50 to sit on the seat formed by the two seat plates 32. As the seat plates 32 are loaded with the weak person 50, the seating arms 312 tilt in a lever action and the position restoring elements 314 are extended. Each of the seating arms 312 moves away from the lower guard stop 3111 and comes in contact with the upper guard stop 3112. During this movement, weight of the weak person 50 is transferred from the armpit supporting device 23 onto the newly formed seat, with the person naturally looking forward in an upright posture. The transport apparatus would then be controlled, by the weak person 50 or by others, to transport the weak person 50 to other locations, such as a location with a toilet, or wheelchair, or sofa or dining table, et cetera.

In a scenario where the weak person instructs the transport apparatus to move to a location with a toilet, the transport apparatus would move to a set position close to the toilet, turns 180 degrees to position the support wheels 13 towards the toilet, then the lifting arm 22 and the armpit supporting device 23 are raised in a curved track, bringing the weak person away from the seating position. At this time the two seat plates 32 would spin to an upper position, and the transport apparatus would move closer to the toilet so the two support wheels 13 are on the left and right side of the toilet respectively, and this would position the hip of the weak person above the toilet seat. Then the lifting arm 22 and the armpit supporting device 23 are lowered in a curved track so the weak person goes to a seating position on the toilet seat. The weak person would release his/her hands on the handle 233, and sit upright on the toilet seat.

With the transport apparatus for the weak person 50 as described above, the weak person 50 can be moved directly by the transport apparatus and the transport apparatus can be operated by voice command from the weak person 50 or the care workers, or by the remote control which is under the control of the weak person 50 or the care workers. Since the weak person 50 is not moved by the care workers, the weak person 50 can be moved in an easier way.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A transport apparatus for weak person comprised of:
a mobile chassis;
a lifting mechanism comprised of
an actuator assembled on the mobile chassis;
at least one lifting arm connected to and extending from the actuator, and driven to pivot upward or downward by the actuator; and
an armpit supporting device assembled on an upper end of the lifting arm; and
a seating assembly comprised of
a seat supporting mechanism mounted on the mobile chassis; and
two seat plates mounted on two seating arms of the seat supporting mechanism, and connected to and driven by two driving assemblies respectively to form a seat.

2. The transport apparatus as claimed in claim 1, wherein two motorized wheels are assembled on a front portion of the mobile chassis and are located on left and right sides of the mobile chassis respectively; and multiple supporting wheels are assembled on the rear portion of the mobile chassis.

3. The transport apparatus as claimed in claim 1, wherein the armpit supporting device is comprised of
a chest rest mounted on the upper end of the lifting arm; and
two embracing arms mounted on left and right sides of the chest rest respectively.

4. The transport apparatus as claimed in claim 3, wherein the distance between the two embracing arms is adjustable.

5. The transport apparatus as claimed in claim 1, wherein
the seat supporting mechanism is comprised of
two mounting columns mounted on the mobile chassis and located on left and right sides of the mobile chassis respectively, and each of the mounting columns having a lower guard stop, an upper guard stop and a pivot on the upper end of the column;
two seating arms connected to the pivots on the upper ends of the mounting columns respectively and this allows a seesaw movement of the seating arms between the upper and lower guard stops, each of the seating arms having a front end extending toward a front portion of the mobile chassis and a rear end extending toward a rear portion of the mobile chassis; and
at least one position restoring element connected to one of the seating arms and the mobile chassis; and
the two seat plates are mounted on the rear ends of the left and right seating arms respectively.

6. The transport apparatus as claimed in claim 5, wherein the point where the position restoring element is connected to the seating arm, is located between the pivot and the front end of the seating arm.

7. The transport apparatus as claimed in claim 6, wherein the position restoring element is a tension spring.

8. The transport apparatus as claimed in claim 5, wherein the point where the position restoring element is connected to the seating arm, is located between the pivot and the rear end of the seating arm.

9. The transport apparatus as claimed in claim 8, wherein the position restoring element is a gas spring or a compression spring.

10. The transport apparatus as claimed in claim 5, wherein the seat supporting mechanism is further comprised of a fixed linkage connecting the two seating arms.

11. The transport apparatus as claimed in claim 1, wherein each of the driving assemblies of the seating assembly is comprised of
a motor drive; and
a gear set connected to the motor drive and the seat plate;
wherein the motor drives of the driving assemblies drive the seat plates to rotate via the gear set.

12. The transport apparatus as claimed in claim 11, wherein each of the seat plates has
a connecting portion mounted on the seating arm and is connected to the gear set; and
a sitting portion;
the included angle between the connecting portion and the sitting portion is 135 degrees.
